(19) United States
(12) Patent Application Publication
(10) Pub. No.: US 2003/0006295 A1
(43) Pub. Date: Jan. 9, 2003

(54) Spraying apparatus

(76) Inventors: Glenn Kenny, Gympie (AU); Lauritz John Rasmussen, Wolvi (AU); Warren Lyell Duthie, Gympie (AU)

Correspondence Address: Shoemaker and Mattare, 2001 Jefferson Davis Highway, Suite 1203, Arlington, VA, 22202, US

(21) Appl. No.: 10/159,159

(22) Filed: Jun. 3, 2002

Related U.S. Application Data
(63) Continuation of application No. PCT/AU00/00801, filed on Jun. 30, 2000.

(30) Foreign Application Priority Data
Feb. 24, 2000 (AU) 19458/00
Apr. 14, 2000 (AU) PQ6919
Apr. 14, 2000 (AU) 27787/00

(51) Int. Cl. B05B 9/06

(52) U.S. Cl. 239/77; 239/78; 239/172; 239/159; 239/550; 239/164; 239/14.1

(57) ABSTRACT

The invention relates to an assembly for a spaying apparatus (10) which includes a ducting assembly (11) mountable about a fan (24), said ducting assembly (11) includes a plurality of ducts (28) formed by a plurality of vanes (29), each of said vanes (29) has a substantially constant width from a duct inlet (32) to a duct outlet (17, 18); a guide member locatable adjacent the ducting assembly (11) and on which the fan (24) is mountable, said guide member (33a) is shaped to direct fan forced air from the guide member (33a) to the duct inlet (32); and spray supply means (19) for providing ducted air with liquid to form spray.

### FIELD OF INVENTION

This present invention relates to agricultural spraying apparatus. This invention has particular but not exclusive application to spraying apparatus for spraying of orchard trees and the like which have a foliage canopy.

### PRIOR ART

Conventional sprayers comprise a vehicular frame supporting a tank containing liquid to be sprayed, a fan housing with one or more outlets disposed radially thereon, spraying nozzles positioned within the outlet, and a fan within the housing capable of drawing air into the housing. The housing may include vane straighteners to direct the forced air though the outlets. In use air is drawn by the fan and forced through the outlets where spray is released from the spray nozzle thereby creating a fog or mist of spray.

Conventional sprayers discharge spray at relatively high velocity. The spray mist or fog is able to coat the outside surfaces of the foliage canopy of trees and plants but is prevented or “locked out” of penetrating the foliage canopy and coating the surfaces inside of the foliage canopy because of the force of the discharging spray forming a foliage barrier. As a consequence only part of the tree or plant is subjected to the spray.

An example of a conventional spraying apparatus used to spray orchards is disclosed in U.S. Pat. No. 4,019,682 where the apparatus includes a trailer frame, a tank and a fan housing having a fan mounted therein and a series of vanes to direct forced air through outlets. Spray nozzles are positioned within the outlets so that released spray is carried by the forced air to the trees or plants.

In another example international patent publication W093/17551 describes a spraying apparatus having a trailer frame with a tank, a fan and a tower assembly with air passages formed therein and through which fan forced air passes and is discharged through outlets. There is also a number of spray nozzles arranged along the tower assembly in the air passage outlets so that fan forced air forces spray from the nozzles outwardly onto the adjacent trees.

With reliance on high velocity, the conventional spraying apparatus has limited range and foliage penetrability. The high velocity produces a spray with a relatively large droplet size. As a consequence the spray with relatively large droplets is only able to be carried comparatively short distances. Thus in practice, trees taller than 4 meters cannot normally be evenly sprayed with a conventional sprayer. Furthermore spray distribution is also affected by the size and shape of the tree canopy and trees with large canopies do not receive an even spray over their entire canopy. With regards to penetrability and as discussed above, high velocity spray can cause foliage lockout preventing spray from entering the canopy.

The problem in achieving effective spray application is further compounded by the fact that different crops such as vineyards and orchards of macadamia trees have different foliage characteristics and require different treatments to achieve even spray distribution. Unfortunately conventional sprayers do not appear to effectively address this problem.

### SUMMARY OF THE INVENTION

In one aspect the invention broadly resides in an assembly for a spraying apparatus including

a fan;

a ducting assembly mountable about a fan, said ducting assembly includes a plurality of ducts formed by a plurality of vanes, each of said vanes has a substantially constant width from a duct inlet to a duct outlet;

a guide member locatable adjacent the ducting assembly and on which the fan is mountable, said guide member is shaped to direct fan forced air from the guide member to the duct inlet; and

spray supply means for providing ducted air with liquid to form spray.

Preferably there is a compression ring locatable adjacent the ducting assembly and mountable about the fan. The compression ring contains the fan forced air and serves as an antislip ring preventing slippage of the fan forced air. The width of the duct preferably governs the compression factor. The guide member is preferably arcuate or curved in shape.

The “positioning of the vanes adjacent the perimeter of the fan” means the vanes are at or closely next to the fan perimeter without the vanes touching the fan blades. The arrangement of the duct inlets relative to the guide member and fan is such that fan forced air is directed to the ducts without the creation of high and low pressure regions in the region therebetween. The duct outlet is preferably located at or adjacent to an outer edge of the duct assembly.

The duct inlet is preferably adjacent the fan perimeter. The duct inlet may extend inwardly or outwardly to a position preferably no further than where the inlet position creates turbulence. The duct inlet is preferably located in use adjacent the fan perimeter along a line parallel with the fan axis. The meaning of the phrase “adjacent the fan perimeter along a line parallel with the fan axis” includes positioning of the vane up to 10 millimeters inwardly or outwardly of a position on a line parallel with the fan axis and the fan perimeter.

The width of the vanes may range from a position where the production of discharged fan forced air has a maximum velocity to a position where the production of discharged fan forced air has a maximum volume. The width of the vanes in accordance with one embodiment may range between 130 and 250 millimeters where the lower widths cause fan forced air to be discharged from the ducts with relatively high velocity and low volume whereas the higher widths cause fan forced air to be discharged from the ducts with relatively high volume and low velocity.

The width of each of the vanes may be fixed in each assembly. Alternatively the width of the vanes may be adjustable so that the opposing planar surfaces forming the duct passages with the vanes move closer together or apart from each other. The vanes may be adjustable with expandable width portions. In one preferred form each of the vanes have two or more width portions that are slidable relative to each other. The width of the vanes formed by the slidable width portions is uniformly fixed by suitable fixing means so that the vane widths are substantially constant between the duct inlet and the duct outlet.

In one preferred form the vanes are arranged substantially equidistant around 360 degrees of the fan perimeter. The lower part of the fan is not blocked in this preferred form. The arrangement of the vanes around the perimeter of the fan preferably provides substantially equal volumes of discharged air to either side of the ducting assembly. The provision of substantially equal volumes of discharged air to either side of the ducting assembly preferably provides the substantially equal distribution of spray either side of the ducting assembly.

In one preferred form the ducting assembly has a vane positioned at the lowest point on the fan perimeter thereby serving as a baffle to direct the generated air to either side of the fan into adjacent ducts.

In one form where there are vanes arranged substantially equidistant around 360 degrees of the fan perimeter the position of the fan mounting is raised from the ground compared with the position of the fan mounting of the conventional sprayers.

Preferably each duct has an internal passage that expands from a duct inlet to a duct outlet. In this way escaping generated air proceeds largely unimpeded and does not cause subsequent turbulence in the fan region. Preferably the duct provides a passage for discharging air without substantially increasing the air velocity between the duct inlet and the duct outlet. More preferably the duct provides a passage for discharging air to maintain volume without substantially increasing the air velocity between the duct inlet and the duct outlet.

Preferably each duct has an internal passage that expands from a duct inlet to a duct outlet, thereby enabling production of a low density spray at a relatively low velocity while maintaining substantially maximum volume.

The duct inlets in one preferred embodiment have an internal passage that can allow a stream of air to move in a direction along a line extending radially from the fan axis to the duct outlet without interference or deflection by the duct vanes thereby limiting the creation of air turbulence. The radially extending line is preferably in-line with a fan blade.

In a more preferable form a plurality and more preferably all of the ducts have a passage that can allow a stream of air to move in a direction along a line extending radially from the fan axis to the duct outlet without interference or deflection by the duct vanes.

In one preferred form the spraying apparatus has a fan with a plurality of vanes extending from the fan perimeter and positioned substantially equidistant around the fan perimeter and with each duct formed by the vanes having an internal passage that expands from the duct inlet to the duct outlet. In this preferred form the duct outlets face outwardly either side of the fan.

Each of the plurality of ducts preferably has an individual duct inlet and duct outlet.

The ducting assembly preferably has a plurality of upper and lower ducts. Preferably the upper duct outlet is upwardly spaced from the fan and the lower duct outlet is laterally spaced from the fan and lower duct outlet is horizontally disposed from the fan further than the upper duct outlet.

The spray supply means preferably includes a spray outlet which releases spray from fluid stored in a reservoir. The spray outlet is preferably a nozzle and the amount of spray released from the nozzle may be controlled by a valve. The nozzle is preferably located substantially at or within the duct outlet. Preferably all but only some of the duct outlets have a spray nozzle.

The distribution of spray preferably relies substantially on the volume of air discharged rather than the velocity of discharging air thereby creating a less dense spray mist with a relatively small droplet size. A less dense spray at a relatively lower velocity appears to provide a substantially better penetration of foliage canopy.

In one form the ducting assembly includes an upper duct outlet upwardly spaced from said fan and a lower duct outlet laterally spaced from said fan. The upper duct outlet preferably substantially faces a proximal outer side of the foliage canopy and the lower duct outlet substantially faces a distal inner side of the foliage canopy. Preferably the duct outlets on either side of the fan face outwardly so that foliage on either side of the fan can be sprayed. In one form the positioning of the lower duct outlets is adjustable with a laterally extending portion of the lower duct movable about a pivot to change the attitude of the corresponding outlets.

In another aspect the invention broadly resides in a spraying apparatus including:

a fan;

a fan housing;

an assembly as described above; and

a vehicular frame on which the fan and the assembly is mounted.

The fan housing preferably includes a compression ring which serves as an antislip ring to prevent slippage of the fan generated air.

In one form the spraying apparatus includes a wheeled frame with a fan, fan housing, ducting assembly and spray supply means mounted thereto. The spray supply means may include a reservoir for storing the spraying fluid.

The assembly may be any form or combination of features described above.

In a further aspect the invention broadly resides in a method of spraying using the aforementioned spraying apparatus including:

generating forced air from said fan;

ducting the forced air through said ducting assembly to said upper and lower outlets; and

releasing spray to the ducted air from said spray supply means.

Preferably where the spraying apparatus has a upper and lower ducts the proximal outer side and distal inner side of the foliage canopy is sprayed.

In the above method the velocity of the forced air is controllable. It is preferable to have discharged air with a relatively low velocity to produce a low density spray while maintaining a substantially maximum volume.

Preferably the fan is as described above and operates efficiently to produce a relatively large volume of ducted air at a relatively lower velocity. Air-suspended spray that has not coated a surface is preferably extracted from around and in the canopy as the spraying apparatus moves forward and reused. The extracting of air-suspended spray may coat foliage surfaces as it is drawn towards the fan. In another aspect the broadly resides in a spraying apparatus assembly for mounting to a conventional sprayer comprising a ducting assembly mountable about a fan, said ducting assembly includes a plurality of ducts formed by a plurality of vanes, each of said vanes extend with a substantially constant width from adjacent the fan perimeter to an outer edge of the ducting assembly wherein a plurality of duct inlets are formed adjacent the fan perimeter and a plurality of duct outlets are formed at the outer edge of the ducting assembly; a guide member locatable adjacent the ducting assembly and on which the fan is mountable, said guide member is shaped to direct fan forced air from the guide member to the duct inlet; and spray supply means for providing ducted air with liquid to form spray.

The spraying apparatus assembly preferably has a guide member that is arcuate or curved and has a compression ring for preventing slippage of the fan forced air locatable adjacent the ducting assembly and mountable about the fan.

### BRIEF DESCRIPTION OF THE DRAWINGS

In order that this invention may be more readily understood and put into practical effect, reference will now be made to the accompanying drawings which illustrate a preferred embodiment of the invention and wherein:

FIG. 1 is a diagrammatic view of the preferred embodiment of the spraying apparatus of the present invention;

FIG. 2 is an exploded view of the preferred embodiment of the spraying apparatus;

FIG. 3 is a rear view of the preferred embodiment of the spraying apparatus;

FIG. 4 is a diagrammatic view of the preferred embodiment of the spraying apparatus showing in (a) the flow of ducted air and spray from the duct outlets and in (b) the drawing of air suspended spray from around the tree canopy when the spraying apparatus has moved forward;

FIG. 5 is a diagrammatic view of an alternative embodiment of upper and lower ducts;

FIG. 6 is a diagrammatic view of one side of another alternative embodiment of an upper and lower duct arrangement; and

FIG. 7 is a diagrammatic view of the region including the fan, duct inlet and guide member.

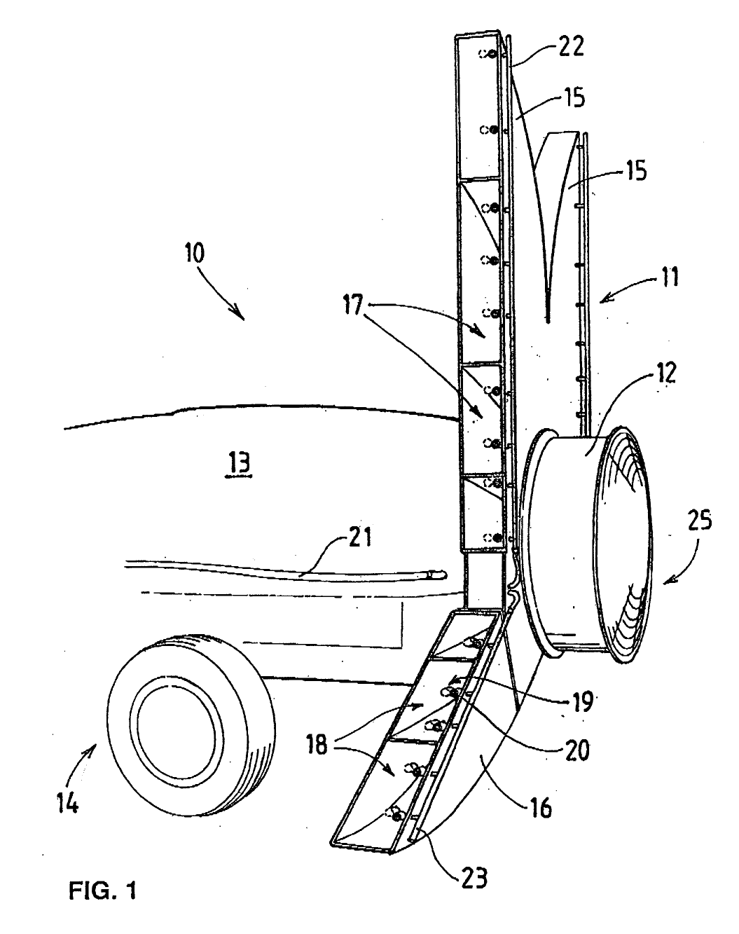

### DETAILED DESCRIPTION OF THE PREFERRED EMBODIMENT

With reference to FIG. 11 there is shown a spraying apparatus 10 which includes a ducting assembly 11, a fan housing 12, a tank 13 for storing liquid to be sprayed and a trailer frame 14. The ducting assembly 11, fan housing 12 and tank 13 are mounted to the trailer frame 14 so that the spraying apparatus can be towed by a tractor or the like up and down rows of trees such as in an orchard or vines such as in a vineyard.

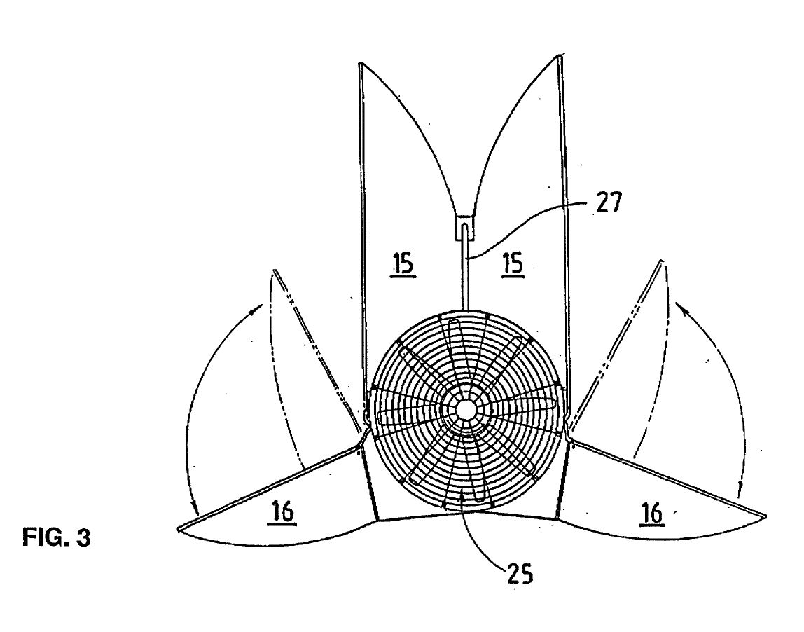

The ducting assembly 11 includes two vertically disposed wings 15 and two horizontally disposed wings 16. With reference to FIG. 3 the horizontally disposed wings 16 can be pivoted upwardly when not in use and in transit to the site of use.

Each spray nozzle 19 is regulated by valve 20 adjacent spray nozzle 19. Spray is supplied to the spray nozzle 19 from tank 13 through lines 21, 22, 23.

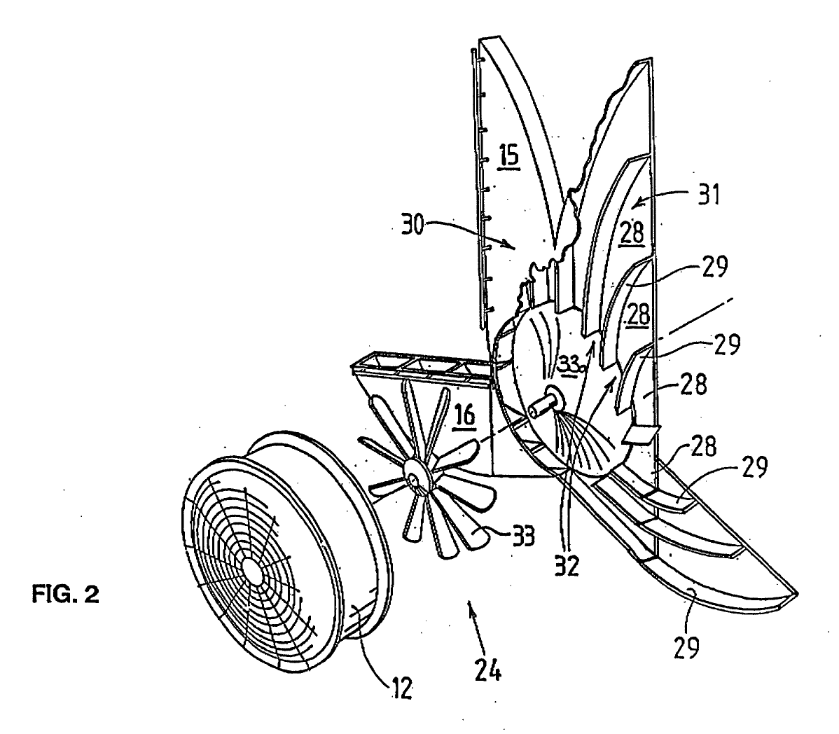

Fan housing 12 surrounds fan 24 which is shown in FIGS. 2 and 3. The open face 25 of the fan housing 12 allows air to be drawn into the fan 24 without substantial hindrance. Conventional sprayers block a lower section of the fan outlet adjacent to the orchard floor to prevent disturbance of the ground cover. This avoids introduction of disturbed debris by the fan intake. By blocking this area of the fan exhaust, turbulence is created in the bottom third of the fan. The blocking of the fan in this manner is used throughout the spraying industry.

With the preferred embodiment of the spraying apparatus of the current invention it is desirable to draw in the maximum amount of air as possible. The bottom portion of neither the fan intake or the fan outlet surrounding the perimeter of the fan is blocked. As a result the rotation of the fan is balanced. The increased efficiency is utilised by the horizontally disposed wings to spray the distal foliage.

To support the vertically disposed wings 15, bracing 27 (as shown in FIG. 3) may be used to maintain their position.

With particular reference to FIG. 2, the vertically disposed wings 15 and the horizontally disposed wings 16 have a plurality of ducts 28 defined by vanes 29 and front panels 30 and rear panels 31. The vanes 29 define an internal expanding passage so that there is a minimal amount of air turbulence as air is ducted there through. Duct inlet 32 receives forced air as the blade 33 of the fan 24 passes the inlet 32. Guide member 33a also guides generated fan forced air to the duct inlets 32. The fan blades 33 and the guide member 33a guide fan forced air to the ducts. The vanes 29 at the duct inlet 32 extend adjacent to the perimeter of the fan 24. The vanes 29 at the duct inlet 32 extend adjacent the perimeter of the fan 24 so that air can pass into the duct inlet 32 substantially without air turbulence. The vanes 29 are positioned at a substantially equal distance around the perimeter of the fan 24. The fan 24 acts as an air pump that sequentially passes forced air into each duct as the blades 33 rotate. As the fan 24 rotates at a considerable speed ducted air flowing from duct outlets 17 and 18 provide the appearance that ducted air flows constantly from each of the duct outlets 17, 18 at any one time.

There are a plurality of duct outlets 17, 18 in the vertically disposed wings 15 and horizontally disposed wings 16 respectively. Each of the duct outlets 17, 18 have at least one spray nozzle 19 which releases spray into the ducted air. Each spray nozzle 19 is regulated by valve 20 adjacent spray nozzle 19. Spray is supplied to the spray nozzle 19 from tank 13 through lines 21, 22, 23.

Fan housing 12 surrounds fan 24 which is shown in FIGS. 2 and 3. The open face 25 of the fan housing 12 allows air to be drawn into the fan 24 without substantial hindrance. Conventional sprayers block a lower section of the fan outlet adjacent to the orchard floor to prevent disturbance of the ground cover. This avoids introduction of disturbed debris by the fan intake. By blocking this area of the fan exhaust, turbulence is created in the bottom third of the fan. The blocking of the fan in this manner is used throughout the spraying industry.

With the preferred embodiment of the spraying apparatus of the current invention it is desirable to draw in the maximum amount of air as possible. The bottom portion of neither the fan intake nor the fan outlet surrounding the perimeter of the fan is blocked. As a result the rotation of the fan is balanced. The increased efficiency is utilised by the horizontally disposed wings to spray the distal foliage.

To support the vertically disposed wings 15, bracing 27 (as shown in FIG. 3) may be used to maintain their position.

With particular reference to FIG. 2, the vertically disposed wings 15 and the horizontally disposed wings 16 have a plurality of ducts 28 defined by vanes 29 and front panels 30 and rear panels 31. The vanes 29 define an internal expanding passage so that there is a minimal amount of air turbulence as air is ducted there through. Duct inlet 32 receives forced air as the blade 33 of the fan 24 passes the inlet 32. The vanes 29 at the duct inlet 32 extend adjacent to the perimeter of the fan 24 which is defined by a circle connecting the outer end of blades 33. The vanes 29 at the duct inlet 32 extend adjacent the perimeter of the fan 24 so that air can pass into the duct inlet 32 substantially without air turbulence. The vanes 29 are positioned at a substantially equal distance around the perimeter of the fan 24. The fan 24 acts as an air pump that sequentially passes forced air into each duct as the blades 33 rotate. As the fan 24 rotates at a considerable speed ducted air flowing from duct outlets 17 and 18 provide the appearance that ducted air flows constantly from each of the duct outlets 17, 18 at any one time.

The efficiency created by the above mentioned procedure eliminates the requirement of vanes in the inlet or discharge side of the fan housing used by many conventional sprayers to control the rotational effect on the exhaust from the fan. By the elimination of these devices the fan is no longer choked thus requiring less horsepower to operate and providing a substantial saving in use and thus cost in fuel during the spraying of an orchard.

In one preferred form the spraying apparatus is formed with a kit including the ducting assembly 11 that can be mounted about a fan of conventional sprayers.

In use, air is drawn in through the open face 25 of fan housing 12 by fan 24 and directed into duct inlets 32, forced along the internal passage of ducts 28 and flowing outwardly from duct outlets 17, 18. Spray from the spray nozzle 19 is suspended in the ducted air as it flows outwardly.

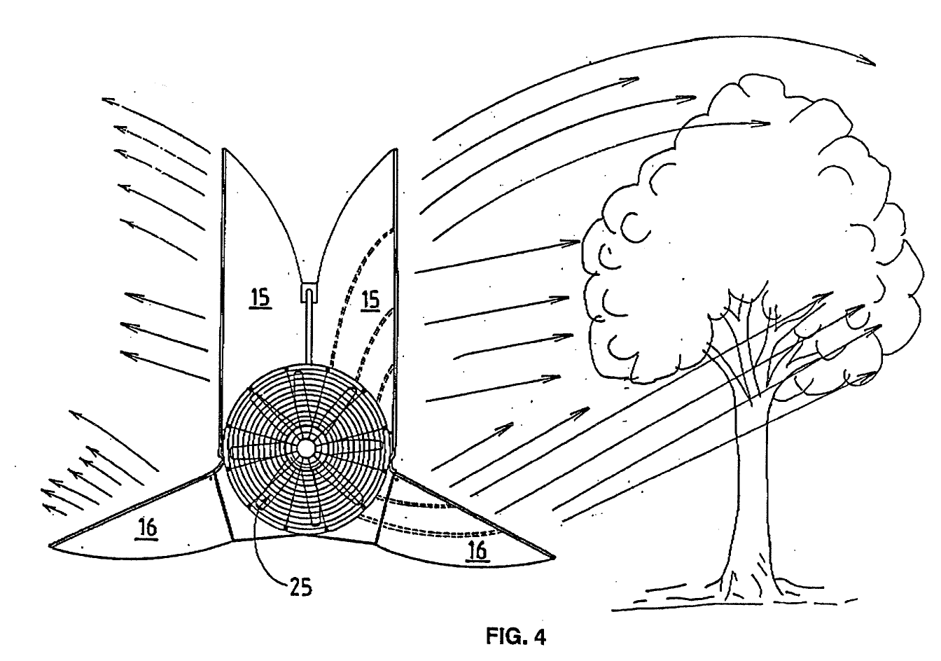

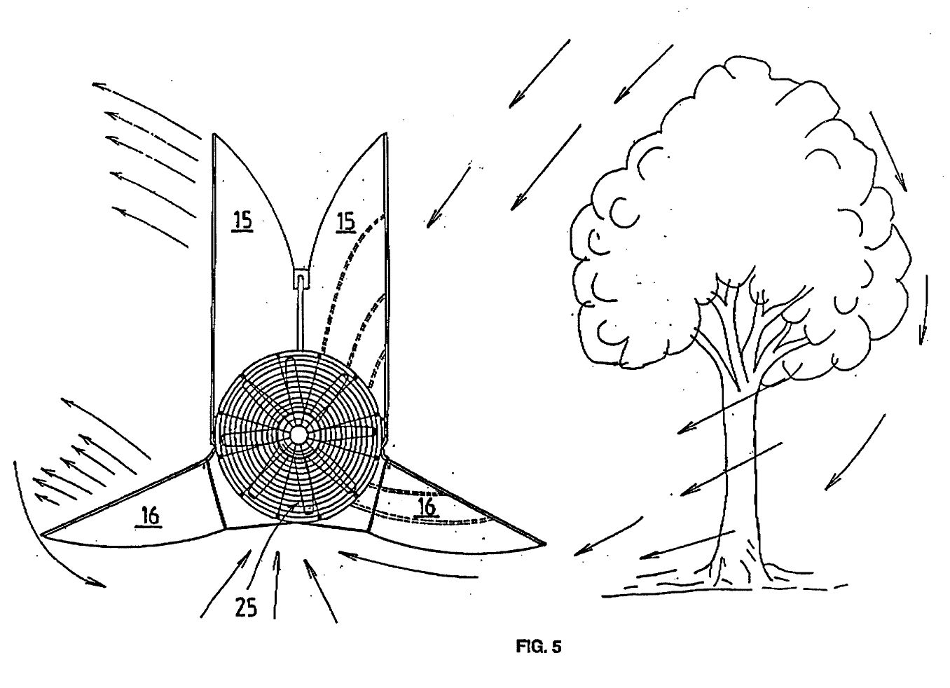

With reference to FIG. 4, air-suspended spray from duct outlets 17 are directed to the closest outer surface of the foliage canopy whereas air-suspended spray from the duct outlets 18 is directed to the under side of the foliage canopy on the other side of the tree. The air-suspended spray coats surfaces exposed on the inner side of the foliage canopy.

As the spraying apparatus moves forward the air-suspended spray is drawn towards the fan. Exposed surfaces may be coated as the fan 24 draws air-suspended spray. Air-suspended spray from within the canopy is drawn into the fan 24. Air-suspended spray that had been locked out by the outer surface of the canopy is drawn into the fan 24. The air-suspended spray forced above the canopy is drawn towards the fan 24 either directly or moving around the outer surface of the foliage canopy on the other side of the tree.

Air spraying mixture from the vertically disposed wings acting upon the proximal side of the tree canopy brings into effect tree lockout. This in conjunction with the orchard floor creates the effect of a three-sided tunnel. As the sprayer moves forward the volume of air being removed by the fan creates an imploding effect to generate the above mentioned condition.

In this way any spray that has not been used can be drawn into the spraying apparatus for re-use. This is possible as the efficiency of the fan is maximised for volume as opposed to velocity of ducted air and the majority of air-suspended spray is within reach of being drawn back to the spraying apparatus.

As a consequence less spray needs to be used for treating trees and vines. There is minimal wind drift of spray as the spray is not forced out at a comparatively high velocity and thus largely remains within the reach of being drawn back into the spraying apparatus. Furthermore the use of the ducting assembly targets specific areas of the tree or vine that is to be treated with spray compared with indiscriminate release of spray with some conventional sprayers. This minimises the amount of spray chemical required and so reduces the cost of spraying an orchard.

The outer canopy surface on the other side of the tree and the inner surfaces of the foliage canopy on the side of the tree closest to the spraying apparatus have largely not been subjected to the spray, but are subjected to the spray when the spraying apparatus moves along the adjacent row and they become the treated proximal outer foliage surface and distal inner foliage surfaces respectively.

It appears that conventional fan sprayers which block the bottom portion of the fan create a compression effect in the bottom third of the fan as the air tries to escape from the right and left hand side of the fan housing above the blocked off portion. When the fan turns in a clockwise rotation, the air escaping from the right hand side is compressed further by air generated by the rotating fan causing a high pressure region and a low volume of discharging air. In contrast the escaping air on the left hand side of the fan is aided by the rotating fan causing a high volume of air to be discharged from the left hand side of the fan. The high volume of air discharging from the left hand side of the fan creates a low pressure region and a venturi effect in the region around the point of discharge.

Further it appears that the control of compression is related to the control of velocity. In the current spraying apparatus it is preferable to have a ducting assembly and fan that avoids the creation of compression points. Compression points within the fan region causes the horse power ratings to be increased for operation of the sprayer.

Also compression points in the fan region subsequently increases velocity which affects the density of the discharged spray. It is desirable to produce a spray that is of low density and relatively low velocity while maintaining substantially maximum volume. Therefore the current invention includes within its scope any design of a ducting assembly and fan that avoids the creation of compression points and a spraying apparatus that is able to produce a low density spray at a relatively low velocity while maintaining substantially maximum volume.

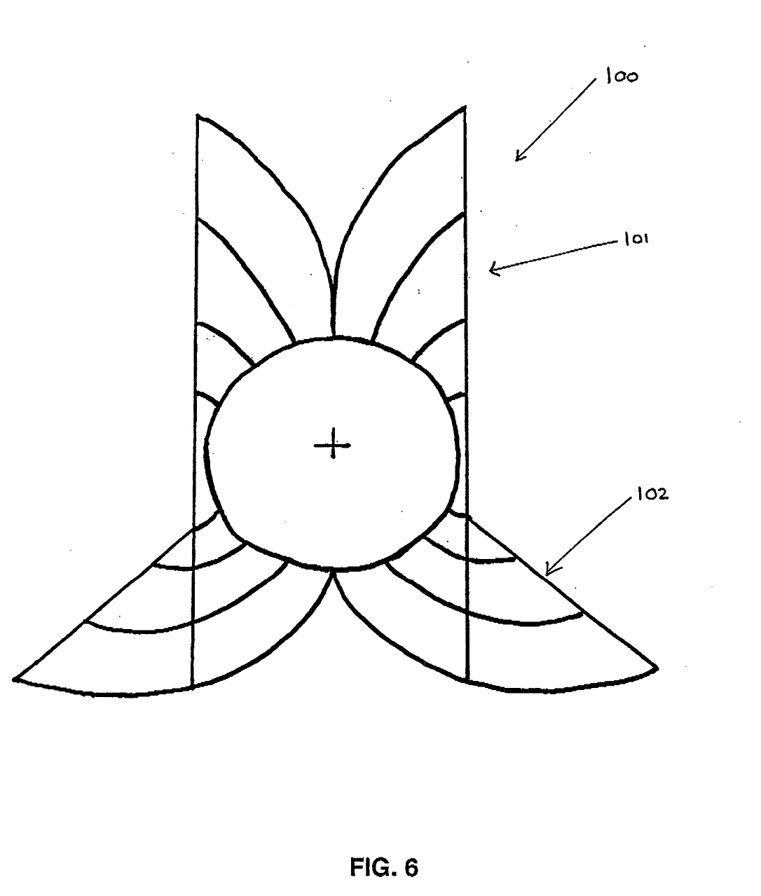

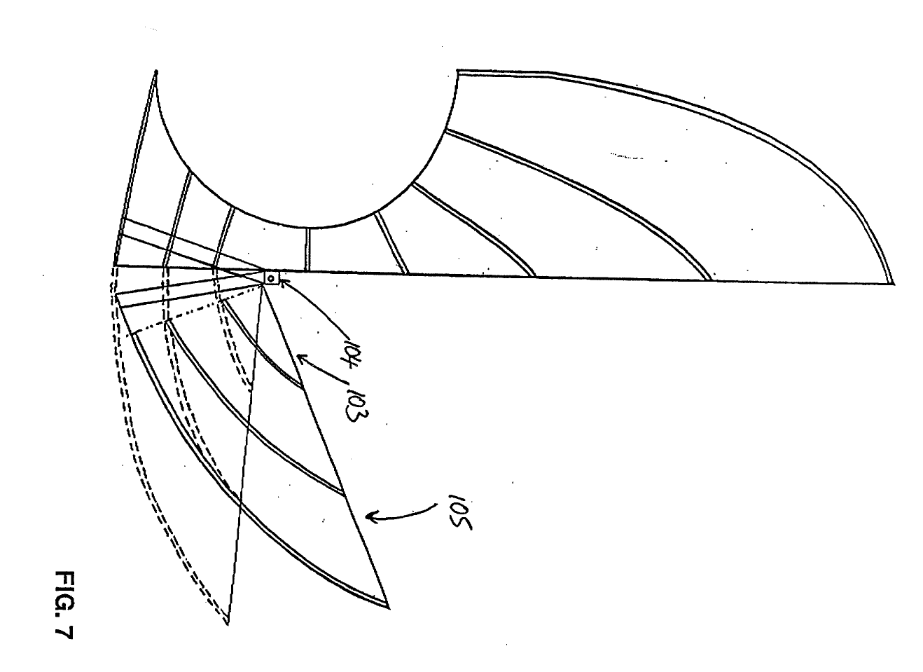

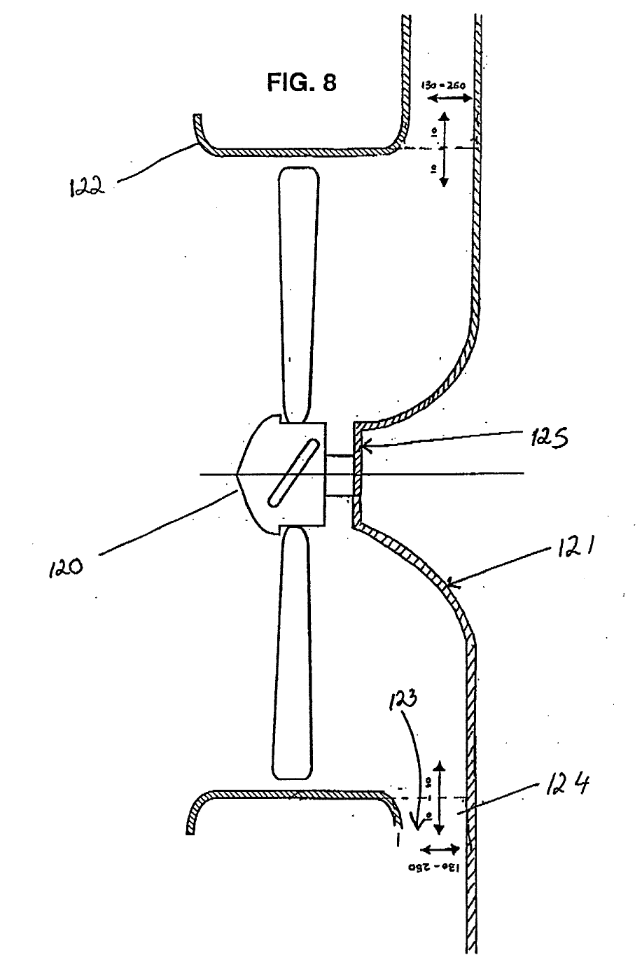

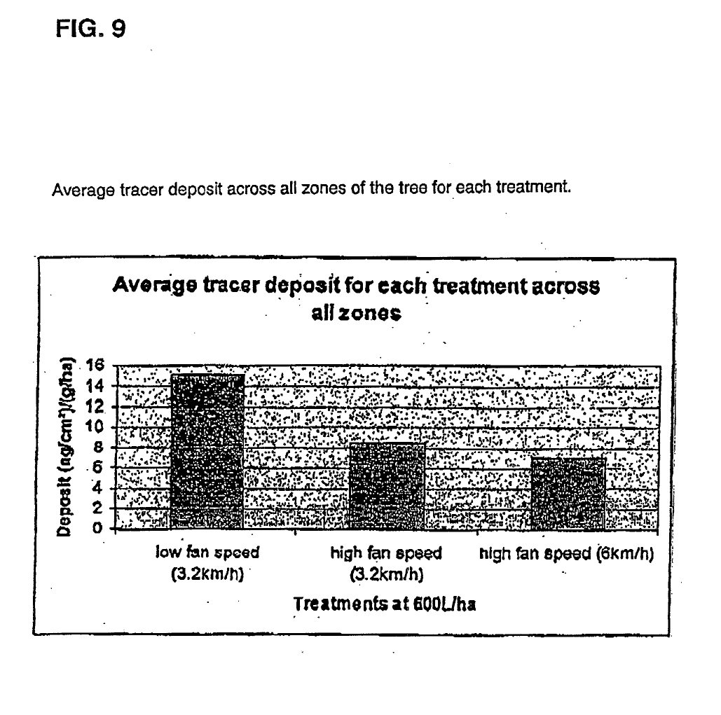

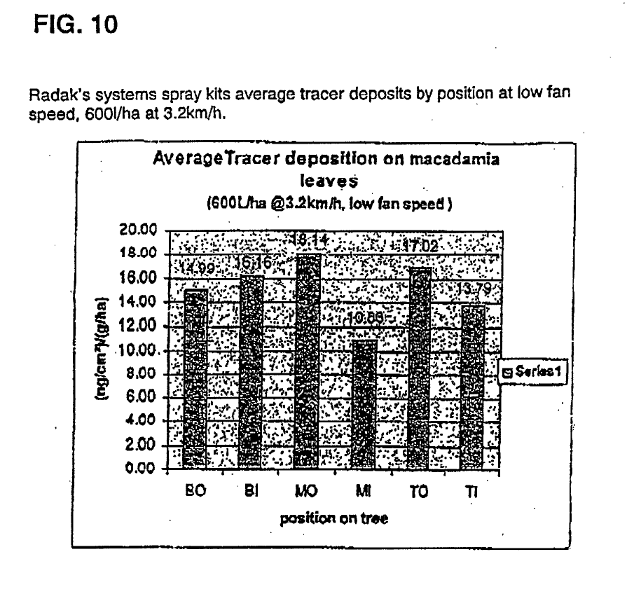

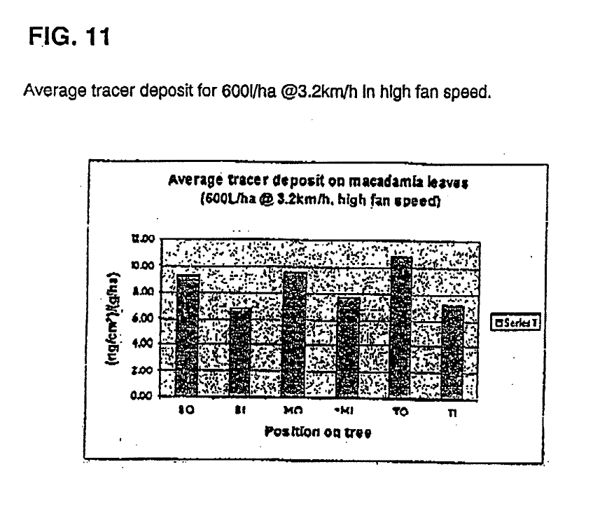

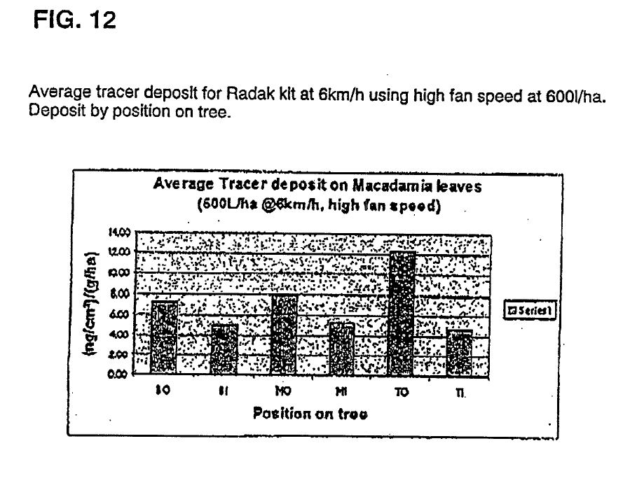

In FIG. 6 there is shown an alternative ducting assembly 100 which includes plurality of upper ducts 101 and a plurality of lower ducts 102. The ducting assembly 100 in use is positioned about a fan (which is not shown). The upper ducts are upwardly spaced from the fan whereas the lower ducts 102 are laterally spaced from the fan. The lower ducts 102 are pivotally adjustable as shown in FIG. 7. The pivotal adjustment of the lower ducts 102 provides duct outlets 103 with a range of attitudes. The pivotal adjustment is a hinge arrangement 104 which provides a portion 105 of the lower ducts 102 to move toward and away from the fan.

In FIG. 8 there is shown a fan 120, an guide member 121, a compression ring 122 and a duct inlet 123. A vane 124 is shown in phantom. The fan 120 is mounted on the guide member 121 at portion 125 so that it stands proud of the guide member 121. The guide member 121 curves from portion 125 to the duct inlet 123. The width of the vane 124 and hence the width of the duct inlet 123 may vary between 130 to 250 mm. The lower the width the greater the velocity of the 20 discharged fan forced air. The vane 124 may extend 10 mm towards the portion 125 or up to 10 mm away from portion 125 from a preferred position where it is in line with the compression ring 122 or on a line parallel to the fan access and at the fan perimeter. In use the air generated from the fan 120 passes rearwardly and is guided to the duct inlet 123 for discharge from the duct outlet.

### Trial with the Spraying Apparatus

A trial was conducted on a macadamia farm to evaluate the performance of the current spraying apparatus. In the trial the spraying apparatus was tested at 600 liters per hectare at 3.2 kilometers per hour comparing low fan speed and high fan speed. The performance of the sprayer was evaluated using a fluorescent tracer and sampling from 6 positions in tree canopy. Using fluorometric analysis the tracer deposits were quantitatively measured at each of the positions. The trial was conducted in a mature macadamia orchard in 16 year old trees 7 metres tall (var 660246). The experiments were performed by the Queensland Department of Primary Industries which is an independent government authority. The results of the experiments are shown in FIGS. 9 to 12. The average deposit of each treatment is shown in FIG. 9. The deposit units are standardised tracer deposits which enables the quantity of tracer recovered to be directly compared without bias. FIG. 9 shows that at low fan speed the sprayer gives approximately 44% better deposit than high fan speed at the same speed and rate per hectare. The high fan speed at 6 kilometers per hour gave approximately 52% less deposit than low fan speed at 3.2 kilometers per hour. At low fan speed (3.2 kilometers per hour) the sprayer produced approximately 15 (ng/cm²) per (g/ha), whereas at high fan speed (3.2 kilometers per hour) approximately 8 (ng/cm²) per (g/ha) was produced. In contrast, a conventional sprayer produces approximately 0.45 (ng/cm²) per (g/ha) in similar experiments. The result from the high fan speed experiment is approximately 1800 percent better than corresponding results with conventional sprayers and the results from the low fan speed experiments is approximately 3300 percent increase in coverage compared with results from conventional sprayers. With reference to FIGS. 10 to 12 BO means bottom outer, BI means bottom inner, MO means middle outer, MI means middle inner, TO means top outer and TI means top inner with respect to a position in the tree.

It will of course be realised that while the foregoing has been given by way of illustrative example of this invention, all such and other modifications and variations thereto as would be apparent to persons skilled in the art are deemed to fail within the broad scope and ambit of this invention as is herein set forth.

1. An assembly for a spraying apparatus comprising:
a fan;
a ducting assembly mountable about the fan, said ducting assembly includes a plurality of ducts formed by a plurality of vanes, each of said vanes extend with a substantially constant width from adjacent the fan perimeter to an outer edge of the ducting assembly wherein a plurality of duct inlets are formed adjacent the fan perimeter and a plurality of duct outlets are formed at the outer edge of the ducting assembly;
a guide member locatable adjacent the ducting assembly and on which the fan is mountable, said guide member is shaped to direct fan forced air from the guide member to the duct inlet; and
spray supply means for providing ducted air with liquid to form spray.

2. An assembly for a spraying apparatus as claimed in claim 1 wherein the guide member is arcuate or curved and there is a compression ring for preventing slippage of the fan forced air locatable adjacent the ducting assembly and mountable about the fan.

3. An assembly for a spraying apparatus as claimed in claim 2 wherein each duct has an internal passage that expands from the duct inlet to the duct outlet.

4. An assembly for a spraying apparatus as claimed in claim 2 wherein the vanes are positioned equidistant around the perimeter of the fan and the duct outlets face outwardly either side of the fan.

5. An assembly for a spraying apparatus as claimed in claim 2 wherein each duct has an internal passage that expands from the duct inlet to the duct outlet and the vanes are positioned equidistant around the perimeter of the fan and the duct outlets face outwardly either side of the fan.

6. An assembly for a spraying apparatus as claimed in claim 4 or 5 wherein there is a baffle at the lowest point on the fan perimeter to direct fan forced air into adjacent ducts.

7. An assembly for a spraying apparatus as claimed in claim 4 or 5 wherein there is an upper duct outlet upwardly spaced from the fan and a lower duct outlet laterally spaced from the fan, said lower duct outlet is horizontally disposed from the fan further than said upper duct outlet.

8. An assembly for a spraying apparatus as claimed in claim 7 wherein there is a plurality of upper and lower duct outlets, said upper duct outlets are positionable to face a proximal outer side of the foliage canopy and said lower duct outlets are positionable to face a distal inner side of the foliage canopy.

9. An assembly for a spraying apparatus as claimed in claim 4 or 5 wherein spray supply means includes a spray nozzle for releasing spray formed from liquid from a reservoir, said spray nozzle is positionable at or within the duct outlet.

10. A spraying apparatus comprising an assembly as claimed in claim 2, a reservoir tank for carrying the liquid spray, and a wheeled trailable frame wherein said assembly and reservoir tank are mounted to the frame.

11. A spraying apparatus assembly for mounting to a conventional sprayer comprising:
a ducting assembly mountable about a fan, said ducting assembly includes a plurality of ducts formed by a plurality of vanes, each of said vanes extend with a substantially constant width from adjacent the fan perimeter to an outer edge of the ducting assembly wherein a plurality of duct inlets are formed adjacent the fan perimeter and a plurality of duct outlets are formed at the outer edge of the ducting assembly;
a guide member locatable adjacent the ducting assembly and on which the fan is mountable, said guide member is shaped to direct fan forced air from the guide member to the duct inlet; and
spray supply means for providing ducted air with liquid to form spray.

12. A spraying apparatus assembly as claimed in claim 11 wherein the guide member is arcuate or curved and there is a compression ring for preventing slippage of the fan forced air locatable adjacent the ducting assembly and mountable about the fan.
